(19) United States
(12) Patent Application Publication
(10) Pub. No.: US 2021/0376662 A1
(43) Pub. Date: Dec. 2, 2021

(54) TRANSMITTER AND RECEIVER CIRCUITRY FOR POWER CONVERTER SYSTEMS

(71) Applicant: IMPERIAL COLLEGE INNOVATIONS LIMITED, London (GB)

(72) Inventors: Juan Arteaga, London (GB); David Yates, London (GB); Paul Mitcheson, London (GB)

(21) Appl. No.: 17/257,044

(22) PCT Filed: Jul. 4, 2019
(86) PCT No.: PCT/GB2019/051892

§ 371 Date: Dec. 30, 2020

(30) Foreign Application Priority Data
Jul. 4, 2018 (GB) 1810947.0

(51) Int. Cl. H02J 50/12; H02M 1/42

(52) U.S. Cl. CPC H02J 50/12; H02M 7/2176; H02M 1/4258; H02M 1/4225

(57) ABSTRACT

Embodiments described herein relate to a driving circuit, comprising: a rectification stage configured to convert an AC input to a rectified AC output; a transmitter coil; and an inverter directly coupled to the rectification stage. The rectified AC output from the rectification stage is fed directly to the inverter and the inverter is configured to convert the rectified AC output from the rectifier to an AC output for the transmitter coil.

### FIELD

Embodiments described herein relate to wireless power transfer. In particular, the present disclosure relates to transmitter and receiver circuitry for power converter systems, such as inductive power transfer systems.

### BACKGROUND

Wireless power transfer has many industrial applications, and devices utilising wireless power transfer, such as wireless toothbrush chargers, wireless charging pads for mobile devices, and wirelessly charged medical devices implanted within the body, continue to grow in popularity.

Inductive power transfer (IPT) is an example of non-radiative wireless power transfer. In a typical inductive power transfer system, an alternating current flows through a transmitter coil. This causes the transmitter coil to produce a time-varying magnetic field. When a receiver coil is placed in the time-varying magnetic field, the magnetic field induces an electromotive force in the receiver coil, which can then be used to drive a load. Thus, power is transmitted wirelessly from the transmitter coil to the receiver coil through the time-varying magnetic field.

Class E and Class EF inverters are currently implemented in the coil driver circuitry in multi-MHz IPT systems because of their soft switching capabilities (i.e. zero voltage switching (ZVS) or zero current switching). ZVS involves switching the transistor in the inverter on/off while there is zero voltage across the drain and the source of the transistor, which minimises switching loss in the transistor, and consequently allows high efficiencies at multi-MHz frequencies to be achieved. In addition, Class E and Class EF inverters conveniently also require only one or more low-side switching devices (e.g. a low-side transistor), which are easy to drive.

The switching device of a Class E or Class EF inverter is connected to the direct current (DC) source through a series inductance, which can be designed either as a finite choke, wherein its inductance is part of the resonating circuit, or as an infinite choke, wherein its inductance has a much larger value, meaning that the current flowing through it can be assumed to be constant. In addition, the infinite choke operates as a low pass filter.

Existing inverters based on the Class E and Class EF topologies are fed from a regulated DC voltage source. The regulated DC voltage source can include a mains-rectification stage with an active power factor correction (PFC) stage, so that power is extracted from the mains with a unitary, or close to unitary, power factor. The mains-rectification stage can be a diode bridge and the active PFC stage can be a switched-mode power supply (SMPS), such as a boost converter.

The inverter converts the regulated DC output of the active PFC stage into a high-frequency alternating current. The alternating current (AC) output from the inverter then flows through a transmitter coil. The alternating current through the transmitter coil produces an alternating magnetic field; when the receiver coil of a receiver device is placed in the magnetic field, an electromotive force is induced in the receiver coil. The induced electromotive force is then rectified to direct current by an IPT rectifier (i.e. a high-frequency rectifier), before being regulated for the intended application using a DC-DC converter.

Current IPT systems therefore include a number of power conversion stages. Accordingly, there exists a need to simplify IPT systems and other power converter systems.

### SUMMARY

Aspects and features of the invention are set out in the appended claims.

According to one aspect of an example of the present disclosure, there is provided a driving circuit, comprising: a rectification stage configured to convert an AC input to a rectified AC output; a transmitter coil; and an inverter directly coupled to the rectification stage, wherein the rectified AC output from the rectification stage is fed directly to the inverter and the inverter is configured to convert the rectified AC output from the rectifier to an AC output for the transmitter coil.

By directly feeding the rectified AC output from the rectification stage to the inverter, the number of power conversion stages in a system in which the driving circuit is implemented is reduced, thereby simplifying the system. The efficiency of the system is also increased, by reducing the number of active power conversion stages. This inherently makes the system more robust and reliable.

The driving circuit may be for a power converter system. In particular, the driving circuit may be for an inductive power transfer system, resulting in a reduced number of power conversion stages in the inductive power transfer system, leading to a simpler, more efficient and more robust and reliable inductive power transfer system.

In being fed directly to the inverter, no active power factor correction may be applied to the rectified AC output from the rectification stage before the rectified AC output is fed to the inverter. Instead, active power factor correction is carried out at the receiving end.

The inverter may have an inductor in series with the rectified AC output from the rectification stage. The inductor may have a large inductance. By having a large inductance in series with the rectified AC output from the rectification stage, the need for filtering of the line inductance (in which an additional capacitance at the input of the inverter is required in order to account for additional filtering at the AC-side to achieve a unitary power factor) is avoided.

The inverter may be a Class E inverter or a Class EF inverter, both of which have a large inductance in series with the rectified AC input and therefore provide the advantages in the previous paragraph. The inverter may alternatively be a push-pull variation of a Class E or Class EF inverter, which provides the same advantages. Because of the large inductance in series between the switching device of the Class E or Class EF inverter and the rectified AC output from the rectification stage, AC line inductive filters and the line inductance have no negative effect on the operation of the system. That is, the infinite choke of the Class E or Class EF topologies is utilised as an input filter, minimising the filtering requirements and components at the input of the inductive power transfer system.

The inverter may operate in open loop, in which the inverter feeds the transmitter coil with a current amplitude that is proportional to the input voltage to the inverter (i.e. the rectified AC output from the rectification stage). When operating in open loop, the inverter provides no control on the amplitude of the current fed to the transmitter coil. This contrasts with operation in closed loop, in which the relationship between the amplitude of the output current and the input voltage is changed by altering the duty cycle or the frequency (i.e. controlling the amplitude of the output current). Operation in closed loop also means that power throughput control may be performed at the transmitting end (in addition to the power throughput control performed by the DC-DC converter at the receiving end). Operation in open loop therefore ensures that operation of the system as a whole is simplified. In addition, operation in open loop means that the inverter can be tuned for optimal operation at a constant frequency and a constant duty cycle, thereby achieving better efficiencies.

The rectification stage may be a diode bridge. When implemented as a diode bridge, the rectification stage does not require any form of control.

The AC input may be a mains AC input. The rectification stage may be configured to convert the mains AC input to a mains-rectified AC output.

The inductive power transfer system may be a multi-MHz inductive power transfer system. That is, the frequency of operation of the inverter may be in the multi-MHz range.

A method may comprise converting an AC input to a rectified AC output using a rectification stage; feeding the rectified AC output from the rectification stage directly to an inverter, wherein the inverter is directly coupled to the rectification stage; and converting the rectified AC output from the rectification stage to an AC output for a transmitter coil using the inverter.

According to another aspect of an example of the present disclosure, there is provided a receiving circuit, comprising: a receiver coil, wherein an electromotive force is induced in the receiver coil when the receiver coil is positioned in proximity to a transmitter coil of a driving circuit; a rectifier configured to convert the induced electromotive force from the receiver coil to a rectified output; and an active power factor correction stage configured to convert the rectified output from the rectifier to a regulated DC output and apply a power factor correction to an AC input to the driving circuit.

By including the active power factor correction stage in the receiving circuit, no active power factor correction stage is required in the driving circuit. The power factor is therefore controlled at the receiving end rather than at the transmitting end. Accordingly, the number of power conversion stages in a system in which the receiving circuit is implemented is reduced, thereby simplifying the system. The efficiency of the system is also increased, by reducing the number of active power conversion stages. That is, no separate DC-DC converter is required in addition to the active power correction stage used in existing systems. This inherently makes the system more robust and reliable.

The receiving circuit may be for a power converter system. In particular, the receiving circuit may be for an inductive power transfer system, resulting in a reduced number of power conversion stages in the inductive power transfer system (i.e. no separate DC-DC converter is required in addition to the active power correction stage used in existing inductive power transfer systems). This leads to a simpler, more efficient and more robust and reliable inductive power transfer system.

That is, by locating the active power correction stage at the receiving end of the inductive power transfer system, both the benefits of (i) locating the active power correction stage after the rectification stage in the driving circuit (which is the case for existing inductive power transfer systems); and (ii) a DC-DC converter necessary for power regulation (as also used in existing inductive power transfer systems) are exploited in a unified power conversion stage. Combining these two controlled power conversion stages significantly reduces the complexity of the driving circuit (i.e. the transmitting end) by eliminating a power conversion stage. This reduces the cost of implementing the inductive power transfer system.

The active power correction stage in the receiving circuit therefore also performs power throughput control. By performing power throughput control at the receiving end, a resonant converter operating in open loop (i.e. with fixed frequency of operation and duty cycle) may be implemented as the coil driver in the driving circuit. This means that the high efficiency features of resonant inverters can be exploited. Further, the drawbacks of operating resonant inverters in closed loop can be eliminated: when the frequency of operation of the resonant inverter is varied, it detunes the resonant tanks (which are tuned for a fixed frequency of operation) and thereby increases losses; and when the duty cycle is varied, the inverter either loses soft-switching or enters into sub-optimal operation (in which the intrinsic diodes of the transistors conduct), which significantly deteriorates the efficiency.

Further, locating the active power correction stage in the receiving circuit allows for actuated power control at the load side, meaning that the load itself determines the amount of power it requires. This means that it is not necessary to employ a communication link between the transmitter and the receiver.

Moreover, including the active power factor correction stage in the receiving circuit ensures that the power extracted from the AC input to the driving circuit has a unitary power factor.

The rectifier may be an IPT rectifier. The rectifier may be a Class D rectifier.

The active power factor correction stage may be configured to regulate the output from the rectifier to provide the regulated DC output. The regulated DC output may be the output voltage of the IPT system.

The active power factor correction stage may be configured to emulate a resistive load. The active power factor correction stage can therefore provide output voltage regulation in addition to power factor correction, without requiring additional components or power conversion stages.

The active power factor correction stage may comprise a switched-mode power supply. The switched-mode power supply may be a boost converter. A boost converter has a large inductance at its input.

The inductive power transfer system may be a multi-MHz inductive power transfer system. That is, the frequency of operation of the inverter may be in the multi-MHz range.

Another method may comprise inducing an electromotive force in a receiver coil when the receiver coil is positioned in proximity to a transmitter coil of a driving circuit; rectifying the output from the receiver coil using a rectifier; converting the rectified output from the rectifier to a regulated DC output using an active power correction stage; and applying a power factor correction to an AC input to the driving circuit using the active power correction stage.

According to a further aspect of an example of the present disclosure, there is provided an inductive power transfer system, comprising: a driving circuit as described in the above paragraphs; and a receiving circuit as described in the above paragraphs.

### BRIEF DESCRIPTION OF FIGURES

Specific embodiments are described below by way of example only and with reference to the accompanying drawings, in which:

FIG. 1 is a block diagram of an existing inductive power transfer system.

FIG. 2 is a block diagram of an inductive power transfer system having an active PFC stage at the receiver side.

FIG. 3 is a circuit diagram of an inductive power transfer system having an active PFC stage at the receiver side and including a Class EF inverter.

FIG. 4 shows experimental waveforms of a first experimental setup having a power factor correction stage at the receiving end.

FIG. 5 shows experimental waveforms of a second experimental setup having a capacitive filter at the receiving end instead of the power factor correction stage included at the receiving end of the first experimental setup.

### DETAILED DESCRIPTION

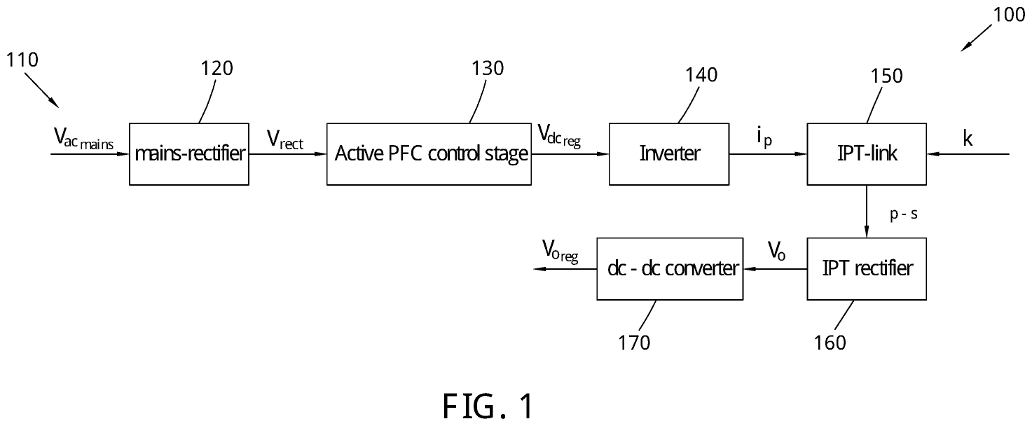

FIG. 1 is a block diagram of an existing IPT system 100. In the IPT system 100 of FIG. 1, a voltage source 110, such as a single-phase mains AC voltage source, V_{ac_mains}, is rectified using a rectification stage 120, such as a diode bridge. The output voltage from the rectification stage 120, V_{rect} has a waveform that is the absolute value of V_{ac_mains} (disregarding the voltage drop across the diodes in the rectification stage).

The rectified AC output from the rectification stage 120, V_{rect}, is fed to an active PFC stage 130, which consists of a switched-mode power supply (SMPS), which is often a boost converter. The active PFC stage 130 ensures that the power is extracted from the mains with a unitary power factor. The output from the active PFC stage 130 is a regulated DC voltage, V_{dc_reg}, which feeds the inverter 140 (i.e. a Class E or Class EF inverter).

The inverter 140 converts the regulated DC output of the active PFC stage 130 into a high-frequency alternating current. The AC output from the inverter 140 is fed to a transmitter coil of an IPT link 150. The IPT link 150 comprises the transmitter coil and a receiver coil, separated by a gap. The alternating current through the transmitter coil, iₚ, creates an oscillating magnetic field which passes through the receiver coil, resulting in an induced EMF, εₚ₋ₛ, creating an alternating current in the receiver coil. The efficiency of the power transfer between the transmitter coil and the receiver coil is influenced by the mutual inductance between the transmitter coil and the receiver coil (represented by the term k in FIG. 1). The mutual inductance is dependent on the geometry of the transmitter coil and the receiver coil, and the distance between the coils.

The induced EMF, εₚ₋ₛ, is rectified using an IPT rectifier 160, resulting in a rectified output. The rectified output is then regulated using a DC-DC converter 170 to control the power throughput so that the output power is regulated for the intended application.

In the examples described herein, an inductive power transfer (IPT) system uses an inverter (such as a Class E or Class EF inverter) fed directly from a rectified AC input (such as a single-phase mains-rectified alternating current (AC) source), in which the power throughput control and the power factor correction (PFC) stages are implemented as a single stage at the receiving end of the IPT system. Accordingly, the examples described below reduce the number of power conversion stages required in an IPT system powered from the mains when unity power factor is required.

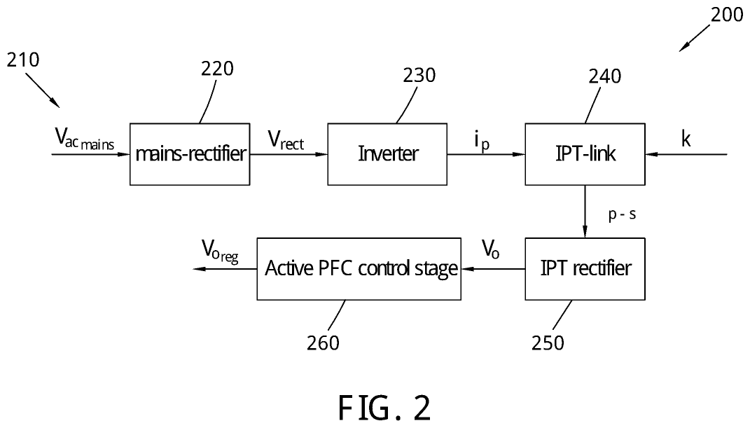

Therefore, in the IPT system 200 in FIG. 2, the Class E or Class EF inverter is not fed by a regulated DC voltage. Accordingly, there is no active PFC control stage between the rectifier and the inverter; that is, the output from the rectification stage 220 is fed directly to the inverter 230.

As with the IPT system 100 of FIG. 1, in the IPT system 200 of FIG. 2, a voltage source 210, such as a single-phase mains AC voltage source, V_{ac_mains} is rectified using a rectification stage 220, such as a diode bridge. The output voltage from the rectification stage 220, V_{rect} has a waveform that is the absolute value of V_{ac_mains} (disregarding the voltage drop across the diodes in the rectification stage).

In contrast to the IPT system of FIG. 1, in the IPT system of FIG. 2, an inverter 230 (which may be a Class E or a Class EF inverter) is then fed with V_{rect} directly (i.e. without a PFC control stage at the transmitting end). The inverter 230 may optionally operate in open loop (i.e. with a constant frequency of operation and constant duty cycle). The inverter 230 has an inductor (i.e. a choke) in series with the rectified AC input, V_{rect}, which serves as an input filter. The amplitude of the output current of the inverter 230 depends on V_{rect}. Therefore, the transmitting coil is driven by a high frequency output current (i.e. the frequency of operation of the inverter). The output current, iₚ, from the inverter 230 has a modulated amplitude that depends on V_{rect}.

Power is then transferred inductively between the transmitter coil and the receiver coil of the IPT link 240, as described above for the IPT system 100 of FIG. 1.

The induced EMF, εₚ₋ₛ, is fed to an IPT rectifier 250, such as a Class D or Class E rectifier. The IPT rectifier 250 may contain a resonating capacitance in series or in parallel with the receiver coil. The IPT rectifier 250 rectifies the high frequency AC current induced in the receiver coil. The IPT rectifier 250 also filters the high frequencies resulting from the inverter's frequency of operation and its harmonics, but not the lower (i.e. twice mains) frequencies. The output voltage from the IPT rectifier 250, V₀, is a rectified AC voltage with a modulated amplitude that depends on the value of V_{rect}.

The next power conversion stage in the IPT system is an active PFC control stage 260. The active PFC stage 260 is used to minimise the effects produced by nonlinear loads (i.e. inductive and capacitive loads) on the mains power supply by emulating a resistive load. This is done by shaping the current provided to the nonlinear load using an SMPS, such as a boost converter.

Accordingly, the active PFC stage 260 shapes the input current to emulate a resistive load to the IPT system 200 such that the power factor at the input of the IPT system 200 is unitary. In addition, the active PFC stage 260, by virtue of its connection to the load being powered, regulates the output voltage for the intended application to control the power throughput of the IPT system 200.

In practice, the power factor may not be completely unitary; references to a unitary power factor herein should be interpreted as encompassing a substantially unitary power factor where the power factor is close to unitary.

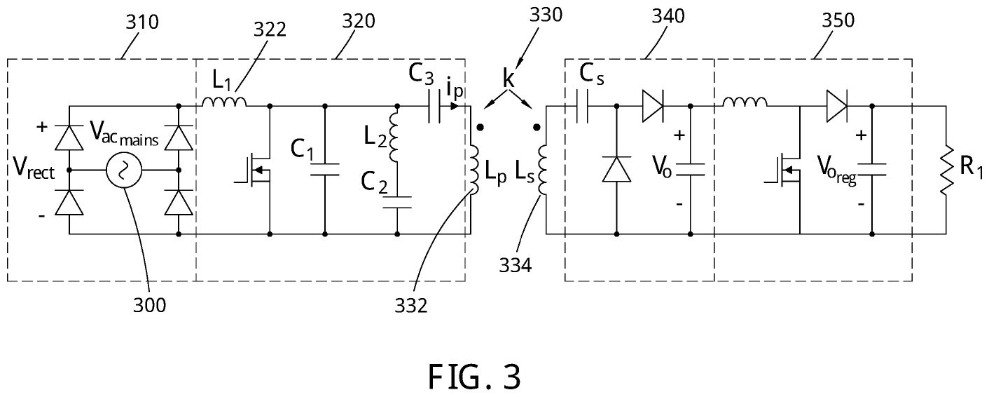

Example components of the block diagram of the IPT system of FIG. 2 are shown in the circuit diagram of FIG. 3, in which the inverter 320 is a Class EF inverter. A diode bridge 310 rectifies the mains voltage input V_{ac_mains} from the mains voltage source 300, resulting in a rectified AC input voltage V_{rect}. The rectified mains voltage V_{rect} is fed to the inverter 320 (which comprises an inductor 322 having a large inductance L₁).

The inverter 320 provides a high frequency AC output (i.e. in the multi-MHz range), which is fed to a transmitter coil 332 of an IPT link 330. The alternating current through the transmitter coil 332, iₚ, induces an EMF, εₚ₋ₛ, in the receiver coil 334 of the IPT link 330, which is then fed to a Class D rectifier 340 (having a series resonant capacitance), which provides an output voltage, V₀.

Finally, the output voltage V₀ is fed to a boost converter 350 which both regulates the power throughput of the system in accordance with the intended application, and emulates a resistive load to shape the input current such that power extracted from the mains has a unitary power factor.

Other embodiments are envisioned that are substantially the same as those described above, but in which the following variations are envisaged.

In particular, with reference to the circuit diagram in FIG. 3, a Class E inverter may be used in place of a Class EF inverter. In this alternative, the circuit would not include inductor L₂ or capacitor C₂. Alternatively, a push-pull variation of a Class E or Class EF inverter may be used in place of the Class EF inverter.

In another alternative, a different SMPS may be used instead of the boost converter 350 of FIG. 3.

In a further alternative, a different rectifier (such as a Class E or Class EF rectifier) may be used instead of the Class D rectifier 340 of FIG. 3.

The application of the above examples is not limited to multi-MHz IPT systems. Thus, the examples described above may also be applied to other IPT systems or to any power converter with magnetic isolation.

### Examples

Two experiments have been performed to show that the power factor controller corrects the power factor at the AC source when implemented in the receiving end of an IPT system. Both experiments power a DC load of 130 W and the wireless link (i.e. the gap between the transmitter and receiver coils) was set at 8 cm.

### Experiment 1:

AC source: 60Vac
Inverter: push-pull load independent Class EF
Transmitter coil: 20 cm, 2 turn PCB coil
Receiver coil: 20 cm, 2 turn PCB coil
Rectifier: full bridge Class D rectifier
PFC stage using LT8312 from Linear Technologies

### Experiment 2:

AC source: 60Vac
Inverter: push-pull load independent Class EF
Transmitter coil: 20 cm, 2 turn PCB coil
Receiver coil: 20 cm, 2 turn PCB coil
Rectifier: full bridge Class D rectifier
No PFC stage; instead, an output capacitance of 100 pF after the IPT rectifier

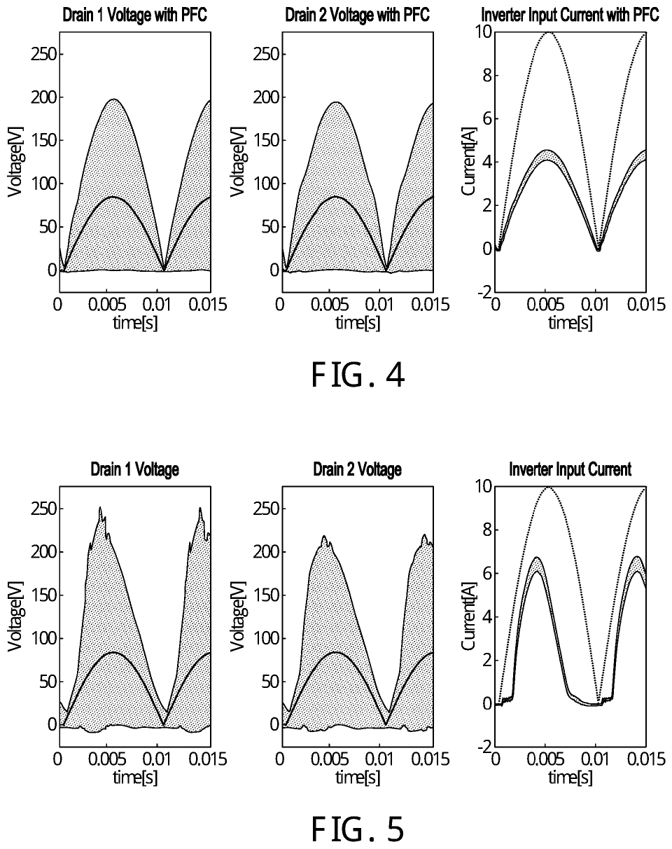

Accordingly, Experiment 1 gave results for an IPT system with an active PFC stage at the receiving end. The drain voltage waveforms (i.e. the voltage measured between the drain and the source of the transistor, with one waveform for each transistor of the push-pull inverter) and the inverter input current waveforms for Experiment 1 are shown in FIG. 4. The power factor in Experiment 1 was 0.9989.

In contrast, Experiment 2 gave results for an IPT system without a PFC stage at the receiving end. The drain voltage waveforms and the inverter input current waveforms for Experiment 2 are shown in FIG. 5. The power factor in Experiment 2 was 0.8519.

It can be seen that the inverter input current waveform in FIG. 4 is the absolute value of a sinusoidal wave in phase with the input-rectified AC voltage, meaning that the power factor in Experiment 1 is close to 1. In contrast, the inverter input current waveform in FIG. 5 is distorted and is phase shifted with respect to the rectified input voltage, meaning that the power factor is reduced.

The drain voltage waveforms in FIG. 4 have lower maximum values than the drain voltage waveforms in FIG. 5, showing that the system performs better when the active PFC stage is implemented at the receiving end (i.e. the experimental setup of Experiment 1 performs better than the experimental setup of Experiment 2).

1. A driving circuit, comprising:
a rectification stage configured to convert an AC input to a rectified AC output;
a transmitter coil; and
an inverter directly coupled to the rectification stage, wherein the rectified AC output from the rectification stage is fed directly to the inverter and the inverter is configured to convert the rectified AC output from the rectification stage to an AC output for the transmitter coil.

2. The driving circuit according to claim 1, wherein no active power factor correction is applied to the rectified AC output from the rectification stage before the rectified AC output is fed to the inverter.

3. The driving circuit according to claim 1, wherein the inverter has an inductor in series with the rectified AC output from the rectification stage.

4. The driving circuit according to claim 1, wherein the inverter is a Class E inverter, a Class EF inverter, or a push-pull variation of a Class E or Class EF inverter.

5. The driving circuit according to claim 1, wherein the inverter operates in open loop.

6. The driving circuit according to claim 1, wherein the AC input is a mains AC input and wherein the rectification stage is configured to convert the mains AC input to a mains-rectified AC output.

7. The driving circuit according to claim 1, wherein the driving circuit is for an inductive power transfer system.

8. The driving circuit according to claim 7, wherein the inductive power transfer system is a multi-MHz inductive power transfer system.

9. A receiving circuit, comprising:
a receiver coil, wherein an electromotive force is induced in the receiver coil when the receiver coil is positioned in proximity to a transmitter coil of a driving circuit;
a rectifier configured to convert the induced electromotive force from the receiver coil to a rectified output; and
an active power factor correction stage configured to convert the rectified output from the rectifier to a regulated DC output and apply a power factor correction to an AC input to the driving circuit.

10. The receiving circuit according to claim 9, wherein the active power factor correction stage is configured to regulate the rectified output from the rectifier to provide the regulated DC output.

11. The receiving circuit according to claim 9, wherein the active power factor correction stage is configured to emulate a resistive load.

12. The receiving circuit according to claim 9, wherein the active power factor correction stage comprises a switched-mode power supply.

13. The receiving circuit according to claim 12, wherein the switched-mode power supply is a boost converter.

14. The receiving circuit according to claim 9, wherein the receiving circuit is for an inductive power transfer system.

15. The receiving circuit according to claim 14, wherein the inductive power transfer system is a multi-MHz inductive power transfer system.

16. An inductive power transfer system, comprising:
a driving circuit comprising:
a rectification stage configured to convert an AC input to a rectified AC output;
a transmitter coil; and
an inverter directly coupled to the rectification stage, wherein the rectified AC output from the rectification stage is fed directly to the inverter and the inverter is configured to convert the rectified AC output from the rectification stage to an AC output for the transmitter coil; and
a receiving circuit comprising:
a receiver coil, wherein an electromotive force is induced in the receiver coil when the receiver coil is positioned in proximity to the transmitter coil of the driving circuit;
a rectifier configured to convert the induced electromotive force from the receiver coil to a rectified output; and
an active power factor correction stage configured to convert the rectified output from the rectifier to a regulated DC output and apply a power factor correction to an AC input to the driving circuit.

17. The inductive power transfer system of claim 16, wherein no active power factor correction is applied to the rectified AC output from the rectification stage before the rectified AC output is fed to the inverter.

18. The inductive power transfer system of claim 16, wherein the inverter has an inductor in series with the rectified AC output from the rectification stage.

19. The inductive power transfer system of claim 16, wherein the active power factor correction stage is configured to emulate a resistive load.

20. The inductive power transfer system of claim 16, wherein the active power factor correction stage comprises a switched-mode power supply.
